(19) United States
(12) Patent Application Publication
(10) Pub. No.: US 2020/0101422 A1
(43) Pub. Date: Apr. 2, 2020

(54) Filtration System and Method of Operating a Filtration System

(71) Applicant: PPG Industries Ohio, Inc., Cleveland, OH (US)

(72) Inventors: Andrew Flowers, Pittsburgh, PA (US); Thomas S. Wong, Sinking Spring, PA (US); Mark A. Shelton, Lancaster, PA (US)

(21) Appl. No.: 16/583,608

(22) Filed: Sep. 26, 2019

Related U.S. Application Data
(60) Provisional application No. 62/738,496, filed on Sep. 28, 2018.

(51) Int. Cl. B01D 65/02; B01D 63/10

(52) U.S. Cl. CPC B01D 65/02; B01D 63/10; B01D 2321/04; B01D 2313/50; B01D 2313/243; B01D 2313/18

(57) ABSTRACT

A filtration system has a filter element with a filtration membrane, a feed inlet and a concentrate outlet on a first side of the membrane and a permeate outlet on a second side of the membrane. A feed line with a feed shutoff valve is in fluid communication with the feed inlet, and a concentrate return line with a concentrate shutoff valve is in fluid communication with the concentrate outlet. A feed pump is in fluid communication with the feed inlet via the feed line and the feed shutoff valve, and a backwash pump is in fluid communication with the permeate outlet. In a priming phase of a backwash operation, the feed shutoff valve and the concentrate shutoff valve are closed and the backwash supply is operable to deliver fluid to the filtration element and equalize pressure between the first side and the second side of the filtration membrane.

### CROSS-REFERENCE TO RELATED APPLICATION

This application claims priority to U.S. Provisional Patent Application No. 62/738,496, filed Sep. 28, 2018, the disclosure of which is hereby incorporated in its entirety.

### BACKGROUND OF THE DISCLOSURE

### Field of the Disclosure

The disclosure relates to a filtration system for filtering a feed flow and a method of operating a filtration system for filtering the feed flow.

### Description of Related Art

Removal of contaminants from wastewater typically involves the use of multiple filtration steps through one or more filter cartridges. Crossflow filter cartridges are used for many water process purification applications because their design permits high filtration membrane efficiency (flux) and prolonged operation time. Crossflow filtration, also known as tangential flow filtration, passes a feed flow under pressure in a direction substantially tangential to the filter membrane surface. Any material smaller than the filter membrane pore (permeate) passes through the filter membrane as a permeate flow, while larger suspended particulates remain in a concentrate flow that is reintroduced into the feed flow.

High concentrations of solids, organics, and bacteria can shorten the lifetime of the filter membrane. Depending on the separation application, there are various types of constituents that can be present in the process water that can reduce the permeate flow over time. Suspended solids can build up on the surface of the membrane or plug the pores of the filter membrane. Emulsified and dissolved organics can adsorb to the surface of the membrane or within the pore structure. Colloidal and dissolved inorganics can precipitate on the surface of the membrane and form a hard scale. Microbiological growth can also occur on the membrane surface, forming a sticky biofilm that agglomerates suspended solids and blocks flow. Such constituents form what is known as “filter cake”, which reduces flux and permeate flow.

Periodic removal of the filter cake can improve filter performance. In some examples, a backwashing operation can be performed, where transmembrane flow is inverted by flowing permeate into the feed to lift the fouling layer of filter cake from the filter membrane surface. Existing backwashing techniques are not suited for thoroughly cleaning the filter membrane surface and may not fully restore the filter performance.

Therefore, there is a need for a filtration system and a method for operating a filtration system that is configured for improved backwashing of the filter membrane surface to remove accumulated constituents from the filter membrane surface.

### SUMMARY OF THE DISCLOSURE

In accordance with some embodiments, a filtration system may have at least one filter element having a filtration membrane, a feed inlet and a concentrate outlet on a first side of the filtration membrane and a permeate outlet on a second side of the filtration membrane. The filtration system may have a feed line in fluid communication with the feed inlet, with the feed line having a feed shutoff valve. The filtration system may further have a concentrate return line in fluid communication with the concentrate outlet, with the concentrate return line having a concentrate shutoff valve. A feed pump may be in fluid communication with the feed inlet via the feed line and the feed shutoff valve, and a backwash supply may be in fluid communication with the permeate outlet. In a priming phase of a backwash operation, the feed shutoff valve and the concentrate shutoff valve are closed and the backwash supply is operable to deliver fluid to the at least one filtration element and equalize pressure between the first side and the second side of the filtration membrane.

In accordance with other embodiments, in a crossflow flush phase of the backwash operation, the feed shutoff valve and the concentrate shutoff valve may be open, and the feed pump and the backwash supply may be operable to deliver the fluid across the filtration membrane in a direction from the permeate outlet through the concentrate outlet. In a concentrate flush phase of the backwash operation, the feed shutoff valve may be closed and the concentrate shutoff valve may be open while the backwash supply may be operable to deliver the fluid across the filtration membrane from the permeate outlet through the concentrate outlet. In a feed flush phase of the backwash operation, the concentrate shutoff valve may be closed and the feed shutoff valve may be open while the backwash supply may be operable to deliver the fluid across the filtration membrane from the permeate outlet through the feed inlet.

In accordance with other embodiments, an operating pressure of the backwash supply may be higher than an operating pressure of the feed pump during the crossflow flush phase of the backwash operation. The filtration system may further have a permeate tank in fluid communication with the permeate outlet. The backwash supply may be in fluid communication with the permeate tank. In some examples, the backwash supply may be an air-operated diaphragm pump. The at least one filtration element may be a crossflow filtration element. The filtration membrane may be a spirally-wound filtration membrane.

In accordance with other embodiments, a method of operating a filtration system may include backwashing at least one filtration element having a filtration membrane, a feed inlet and a concentrate outlet on a first side of the filtration membrane and a permeate outlet on a second side of the filtration membrane. The backwashing may have a priming phase including (a) blocking the feed inlet and the concentrate outlet; and (b) pressurizing the filtration element with a permeate flow through the permeate outlet until a pressure within the at least one filtration element is equalized between the first side and the second side of the filtration membrane.

In accordance with other embodiments, the backwashing may have a crossflow flush phase including (c) unblocking the feed inlet and the concentrate outlet; (d) delivering a feed flow to the at least one filtration element through the feed inlet at a first pressure; (e) delivering the permeate flow to the at least one filtration element through the permeate outlet at a second pressure higher than the first pressure; (f) passing the permeate flow through the filtration membrane to combine the permeate flow with the feed flow; and (g) delivering a combination of the permeate flow and the feed flow out of the at least one filtration element through the concentrate outlet. The backwashing may have a concentrate flush phase following the priming phase, the concentrate flush phase including (h) unblocking the concentrate outlet; (i) delivering the permeate flow to the at least one filtration element through the permeate outlet to pass the permeate flow through the filtration membrane; and (j) delivering the permeate flow out of the at least one filtration element through the concentrate outlet. The backwashing may have a feed flush phase following the priming phase, the feed flush phase including (k) unblocking the feed inlet; (l) delivering the permeate flow to the at least one filtration element through the permeate outlet to pass the permeate flow through the filtration membrane; and (m) delivering the permeate flow out of the at least one filtration element through the feed inlet.

In accordance with other embodiments, blocking the feed inlet and the concentrate outlet may include operating a feed shutoff valve to block flow through the feed inlet and operating a concentrate shutoff valve to block flow through the concentrate outlet. The second pressure may be equal to or higher than a transmembrane pressure during a filtration operation. Delivering the permeate flow may include delivering a permeate fluid through the permeate outlet via a backwash supply. The backwash supply may be an air-operated diaphragm pump. The at least one filtration element may be a crossflow filtration element. The filtration membrane may be a spirally-wound filtration membrane.

The present disclosure can be further described in the following numbered clauses.

Clause 1. A filtration system comprising: at least one filter element having a filtration membrane, a feed inlet and a concentrate outlet on a first side of the filtration membrane and a permeate outlet on a second side of the filtration membrane; a feed line in fluid communication with the feed inlet, the feed line having a feed shutoff valve; a concentrate return line in fluid communication with the concentrate outlet, the concentrate return line having a concentrate shutoff valve; a feed pump in fluid communication with the feed inlet via the feed line and the feed shutoff valve; and a backwash supply in fluid communication with the permeate outlet, wherein, in a priming phase of a backwash operation, the feed shutoff valve and the concentrate shutoff valve are closed and the backwash supply is operable to deliver fluid to the at least one filtration element and equalize pressure between the first side and the second side of the filtration membrane.

Clause 2. The filtration system of clause 1, wherein, in a crossflow flush phase of the backwash operation, the feed shutoff valve and the concentrate shutoff valve are open, and the feed pump and the backwash supply are operable to deliver the fluid across the filtration membrane in a direction from the permeate outlet through the concentrate outlet.

Clause 3. The filtration system of clause 1 or 2, wherein, in a concentrate flush phase of the backwash operation, the feed shutoff valve is closed and the concentrate shutoff valve is open while the backwash supply is operable to deliver the fluid across the filtration membrane from the permeate outlet through the concentrate outlet.

Clause 4. The filtration system of any of clauses 1-3, wherein, in a feed flush phase of the backwash operation, the concentrate shutoff valve is closed and the feed shutoff valve is open while the backwash supply is operable to deliver the fluid across the filtration membrane from the permeate outlet through the feed inlet.

Clause 5. The filtration system of any of clauses 1-4, wherein an operating pressure of the backwash supply is higher than an operating pressure of the feed pump.

Clause 6. The filtration system of any of clauses 1-5, further comprising a permeate tank in fluid communication with the permeate outlet.

Clause 7. The filtration system of any of clauses 1-6, wherein the backwash supply is in fluid communication with the permeate tank.

Clause 8. The filtration system of any of clauses 1-7, wherein the backwash supply is an air-operated diaphragm pump.

Clause 9. The filtration system of any of clauses 1-8, wherein the at least one filtration element is a crossflow filtration element.

Clause 10. The filtration system of any of clauses 1-9, wherein the filtration membrane is a spirally-wound filtration membrane.

Clause 11. A method of operating a filtration system, the method comprising: backwashing at least one filtration element having a filtration membrane, a feed inlet and a concentrate outlet on a first side of the filtration membrane and a permeate outlet on a second side of the filtration membrane, wherein the backwashing comprises a priming phase comprising: (a) blocking the feed inlet and the concentrate outlet; and (b) pressurizing the filtration element with a permeate flow through the permeate outlet until a pressure within the at least one filtration element is equalized between the first side and the second side of the filtration membrane.

Clause 12. The method of clause 11, wherein the backwashing comprises a crossflow flush phase, the crossflow flush phase comprising: (c) unblocking the feed inlet and the concentrate outlet; (d) delivering a feed flow to the at least one filtration element through the feed inlet at a first pressure; (e) delivering the permeate flow to the at least one filtration element through the permeate outlet at a second pressure higher than the first pressure; (f) passing the permeate flow through the filtration membrane to combine the permeate flow with the feed flow; and (g) delivering a combination of the permeate flow and the feed flow out of the at least one filtration element through the concentrate outlet.

Clause 13. The method of clause 11 or 12, wherein the backwashing comprises a concentrate flush phase following the priming phase, the concentrate flush phase comprising: (h) unblocking the concentrate outlet; (i) delivering the permeate flow to the at least one filtration element through the permeate outlet to pass the permeate flow through the filtration membrane; and (j) delivering the permeate flow out of the at least one filtration element through the concentrate outlet.

Clause 14. The method of any of clauses 11-13, wherein the backwashing comprises a feed flush phase following the priming phase, the feed flush phase comprising: (k) unblocking the feed inlet; (l) delivering the permeate flow to the at least one filtration element through the permeate outlet to pass the permeate flow through the filtration membrane; and (m) delivering the permeate flow out of the at least one filtration element through the feed inlet.

Clause 15. The method of any of clauses 11-14, wherein blocking the feed inlet and the concentrate outlet comprises operating a feed shutoff valve to block flow through the feed inlet and operating a concentrate shutoff valve to block flow through the concentrate outlet.

Clause 16. The method of any of clauses 12-15, wherein the second pressure is equal to or higher than a transmembrane pressure during a filtration operation.

Clause 17. The method of any of clauses 11-16, wherein delivering the permeate flow comprises delivering a permeate fluid through the permeate outlet via a backwash supply.

Clause 18. The method of clause 17, wherein the backwash supply is an air-operated diaphragm pump.

Clause 19. The method of any of clauses 11-18, wherein the at least one filtration element is a crossflow filtration element.

Clause 20. The method of any of clauses 11-19, wherein the filtration membrane is a spirally-wound filtration membrane.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 shows a schematic diagram of a filtration system according to some embodiments or aspects of the present disclosure showing fluid flow during a filtration operation of the filtration system;

FIG. 2 shows a perspective view of a filter element of a filtration system, with a section of the filter element cut-away to show various layers of the filter element;

FIG. 3 shows a perspective cross-sectional view of the filter element showing a flow pattern through the filtration membrane;

FIG. 4A is a schematic diagram of the filtration system of FIG. 1 showing fluid flow during a crossflow flush phase of a backwash operation;

FIG. 4B is a schematic diagram of the filtration system of FIG. 1 showing fluid flow during a priming phase of the backwash operation;

FIG. 4C is a schematic diagram of the filtration system of FIG. 1 showing fluid flow during a concentrate flush phase of the backwash operation;

FIG. 4D is a schematic diagram of the filtration system of FIG. 1 showing fluid flow during a feed flush phase of the backwash operation; and

FIG. 5 shows a schematic diagram of a filtration system according to other embodiments or aspects of the present disclosure.

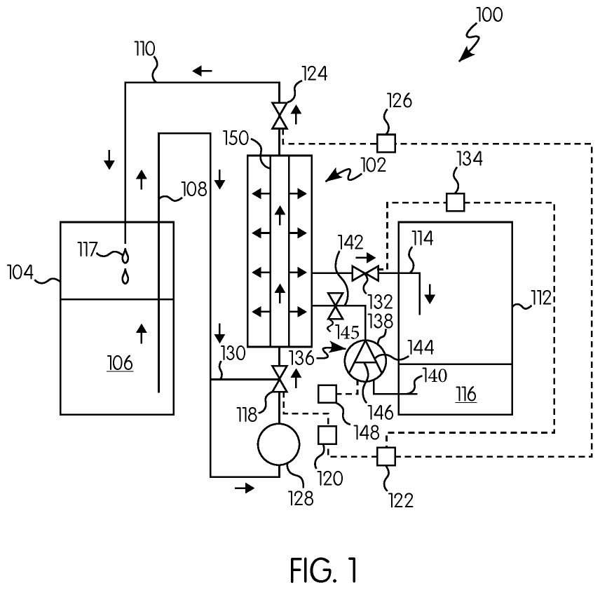

In FIGS. 1-5, like characters refer to the same components and elements, as the case may be, unless otherwise stated.

### DESCRIPTION OF THE DISCLOSURE

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the disclosure as shown in the drawing figures and are not to be considered as limiting as the disclosure can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of various embodiments or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the disclosure.

The disclosure comprises, consists of, or consists essentially of the following examples of the disclosure, in any combination. Various examples of the disclosure may be discussed separately. However, it is to be understood that this is simply for ease of illustration and discussion. In the practice of the disclosure, one or more aspects of the disclosure described in one example can be combined with one or more aspects of the disclosure described in one or more of the other examples.

Referring to FIG. 1, a filtration system 100 has at least one filter element 102 configured for separating materials from a feed solution. In some embodiments or aspects, the filtration system 100 may be an ultrafiltration system configured for pressure-driven separation of particulate and microbial contaminants from the feed solution. It is to be understood that the filtration system 100 may include more than one filter element 102. In embodiments or aspects having a plurality of filter elements 102, the filter elements 102 may be fluidly connected in a series or a parallel arrangement.

With continued reference to FIG. 1, the at least one filter element 102 is in fluid communication with a feed tank 104, such as a storage tank configured for containing a volume of the feed solution 106. The at least one filter element 102 is fluidly connected to the feed tank 104 via a feed line 108 and a concentrate return line 110. The at least one filter element 102 is also in fluid communication with a permeate tank 112 via a permeate outlet line 114. The permeate tank 112 is configured for receiving a permeate product 116 resulting from the feed solution 106 being filtered through the at least one filter element 102. The feed solution 106 that does not pass through the at least one filter element 102, referred to as a concentrate product 117, is returned to the feed tank 104 via the concentrate return line 110.

The feed solution 106 may be any gas or liquid capable of undergoing filtration. For instance, the filtration system 100 may be used to separate the feed solution 106 of wastewater containing contaminants. The contaminants may include oil and other hydrocarbons (e.g., an oil-water separation). However, the filtration system 100 is not limited to use for oil-water separation, and may be used in a broad range of filtering applications, such as for filtering paints, particle filtration, industrial water filtration, gray water filtration, dairy filtration, juice filtration, and the like. The permeate product 116 exiting the filtration system 100 may include at least a portion of the feed solution 106 capable of passing through pores of a filtration membrane of the at least one filter element 102. The concentrate product 117 exiting the filtration system 100 may include at least a portion of the feed solution 106 having a particle size larger than the pore size of the filtration membrane of the at least one filter element 102 and not capable of passing through the filtration membrane. In the example of the oil-water separation above, the permeate product 116 may include at least some of the water from the feed solution 106, which is capable of passing through the filtration membrane of the at least one filter element 102. The concentrate product 117 may include at least some of the oil or other hydrocarbon particles from the feed solution 106 too large to pass through the pores of the filtration membrane of the at least one filter element 102. Thus, in this example, the permeate product 116 may be clean water product (e.g., having fewer contaminants than the feed solution 106), and the concentrate product 117 may be an oil-rich product (e.g., having a higher oil/hydrocarbon concentration than the feed solution 106).

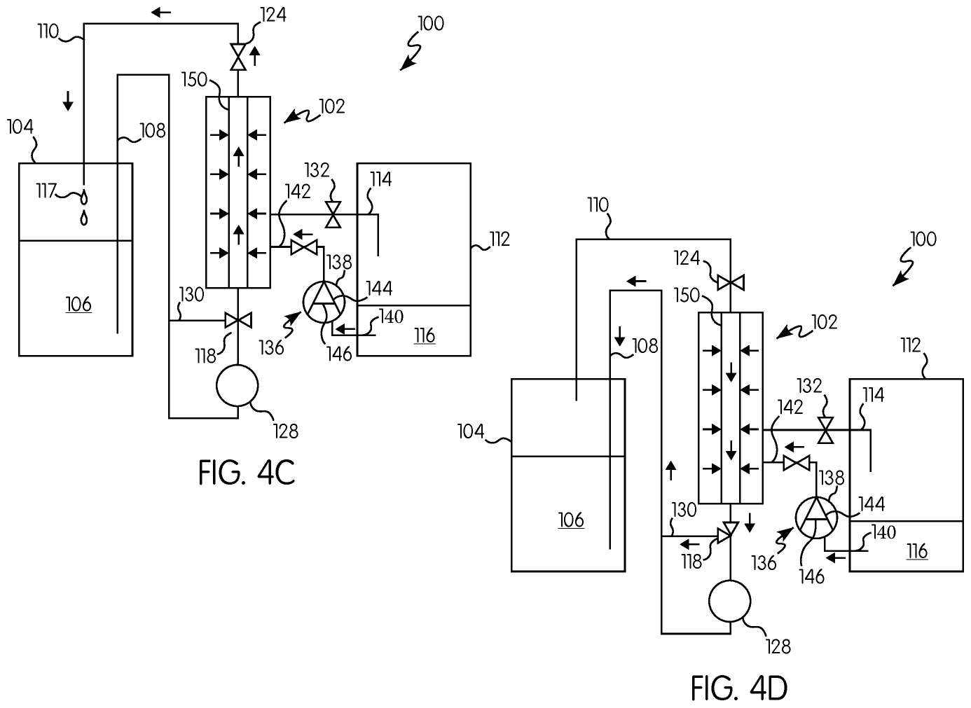

With continued reference to FIG. 1, the feed line 108 has a feed shutoff valve 118 operable between an open position and a closed position. In the open position (FIG. 1), the feed shutoff valve 118 is configured to permit fluid flow through the feed line 108, while, in the closed position (FIG. 4B), the feed shutoff valve 118 is configured to block fluid flow through the feed line 108. In various embodiments or aspects, the feed shutoff valve 118 may be a ball valve, a gate valve, a butterfly valve, a pinch valve, a diaphragm valve, or any other valve that is operable between an open position and a closed position to selectively restrict fluid flow through the feed line 108. In some embodiments or aspects, a plurality of feed shutoff valves 118 may be provided on the feed line 108.

In some embodiments or aspects, the feed shutoff valve 118 may be manually operated between the open position and the closed position. In other embodiments or aspects, the feed shutoff valve 118 may be operated by a feed shutoff valve control device 120. The feed shutoff valve control device 120 may be an electric device, such as a linear or rotary motor, or a solenoid, configured for operating the feed shutoff valve 120 between the open position and the closed position to selectively restrict fluid flow through the feed line 108. In some examples, the feed shutoff valve control device 120 may be a pneumatically-operated or a hydraulically-operated device. Operation of the feed shutoff valve control device 120 may be controlled by a controller 122 operable to execute appropriate custom-designed or conventional software to perform and implement the processing steps for controlling the feed shutoff valve control device 120, thereby forming a specialized and particular computing system.

With continued reference to FIG. 1, the concentrate return line 110 has a concentrate shutoff valve 124 operable between an open position and a closed position. In the open position (FIG. 1), the concentrate shutoff valve 124 is configured to permit fluid flow through the concentrate return line 110, while, in the closed position (FIG. 4B), the concentrate shutoff valve 124 is configured to block fluid flow through the concentrate return line 110. In various embodiments or aspects, the concentrate shutoff valve 124 may be a ball valve, a gate valve, a butterfly valve, a pinch valve, a diaphragm valve, or any other valve that is operable between an open position and a closed position to selectively restrict fluid flow through the concentrate return line 110. In some embodiments or aspects, a plurality of concentrate shutoff valves 124 may be provided on the concentrate return line 110.

In some embodiments or aspects, the concentrate shutoff valve 124 may be manually operated between the open position and the closed position. In other embodiments or aspects, the concentrate shutoff valve 124 may be operated by a concentrate shutoff valve control device 126. The concentrate shutoff valve control device 126 may be an electric device, a pneumatically-operated device, or a hydraulically-operated device. Operation of the concentrate shutoff valve control device 126 may be controlled by the controller 122.

With continued reference to FIG. 1, the feed line 108 has a feed pump 128 configured for pumping the feed solution 106 from the feed tank 104 to the at least one filter element 102. The feed pump 128 may be a dynamic pump, such as a centrifugal pump, or a positive displacement pump, such as a reciprocating pump or a rotary pump. The feed pump 128 may be a single-stage pump or a multi-stage pump. In some embodiments or aspects, operation of the feed pump 128 may be controlled by the controller 122. The feed line 108 may have a bypass section 130 such that the feed pump 128 is bypassed when the feed shutoff valve is in the closed position, as discussed herein. In some embodiments or aspects, a plurality of feed pumps 128 may be provided.

With continued reference to FIG. 1, the permeate outlet line 114 has a permeate shutoff valve 132 operable between an open position and a closed position. In the open position (FIG. 1), the permeate shutoff valve 132 is configured to permit fluid flow through the permeate outlet line 114, while, in the closed position (FIG. 4B), the permeate shutoff valve 132 is configured to block fluid flow through the permeate outlet line 114. In various embodiments or aspects, the permeate shutoff valve 132 may be a ball valve, a gate valve, a butterfly valve, a pinch valve, a diaphragm valve, or any other valve that is operable between an open position and a closed position to selectively restrict fluid flow through the permeate outlet line 114. In some embodiments or aspects, a plurality of permeate shutoff valves 132 may be provided on the permeate outlet line 114.

In some embodiments or aspects, the permeate shutoff valve 132 may be manually operated between the open position and the closed position. In other embodiments or aspects, the permeate shutoff valve 132 may be operated by a permeate shutoff valve control device 134. The permeate shutoff valve control device 134 may be an electric device, a pneumatically-operated device, or a hydraulically-operated device. Operation of the permeate shutoff valve control device 134 may be controlled by the controller 122.

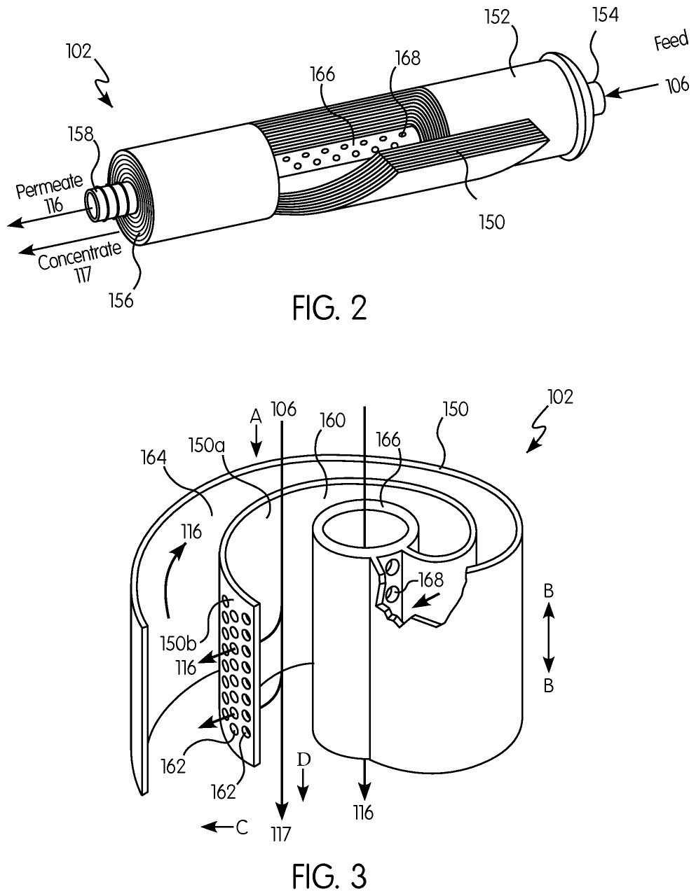

With continued reference to FIG. 1, the filtration system 100 has a backwashing section 136 that is operable during a backwashing operation to remove accumulated constituents from the filter membrane surface of the at least one filter element 102. The backwashing section 136 is configured to deliver the permeate product 116 from the permeate tank 112 to the at least one filter element 102 in a direction opposite to a flow direction of the permeate product 116 during normal filtration operation, as discussed herein. The backwashing section 136 has a backwash supply, such as a backwash pump 138 configured for pumping the permeate product 116 from the permeate tank 112 via a permeate intake line 140 and delivering the permeate product 116 to the at least one filter 102 via a permeate delivery line 142. In some embodiments or aspects, at least a portion of the backwashing section 136, such as the permeate intake line 140 and/or the permeate delivery line 142 may be fluidly connected to the permeate outlet line 114 and/or the permeate outlet 158 of the at least one filter element 102 (shown in FIG. 2). A backwash shutoff valve 145 is provided on the permeate intake line 140 and/or the permeate delivery line 142 to selectively permit or restrict flow through the permeate intake line 140 and/or the permeate delivery line 142.

With continued reference to FIG. 1, the backwash pump 138 may be an air-operated diaphragm pump having a pair of flexible diaphragms 144 connected by a shaft 146 and configured to reciprocate back and forth due to an alternating pressure force exerted by compressed air provided by a compressed air source 148. The flexible diaphragms 144 operate out of phase relative to each other, such that when the first of the pair of flexible diaphragms 144 undergoes a suction stroke, the second of the pair of flexible diaphragms 144 undergoes an exhaust stroke. In this manner, the backwash pump 138 provides a pulsatile flow that helps dislodge accumulated constituents from the filter membrane surface of the at least one filter element 102. The backwash pump 138 is configured to automatically stop operating when the fluid pressure of the pumped fluid, such as the permeate product 116, equals the pressure supplied by the compressed air source 148. Operation of the backwash pump 138 and the compressed air source 148 may be controlled by the controller 122.

In other embodiments or aspects, the backwash pump 138 may be a dynamic pump, such as a centrifugal pump, or a positive displacement pump, such as a reciprocating pump or a rotary pump. One or more valves (not shown) may be provided to control the flow of fluid into the backwash pump 138 and/or out of the backwash pump 138. In this manner, the backwash pump 138 can be operated continuously, while the valves control selective flow of fluid through the filtration system 100 during the backwashing operation. In other embodiments or aspects, the backwash supply may be a pressurized source of fluid stored in a storage reservoir and having a valve configured to selectively release the pressurized fluid from the storage reservoir and deliver the pressurized fluid to the at least one filter element via the permeate outlet.

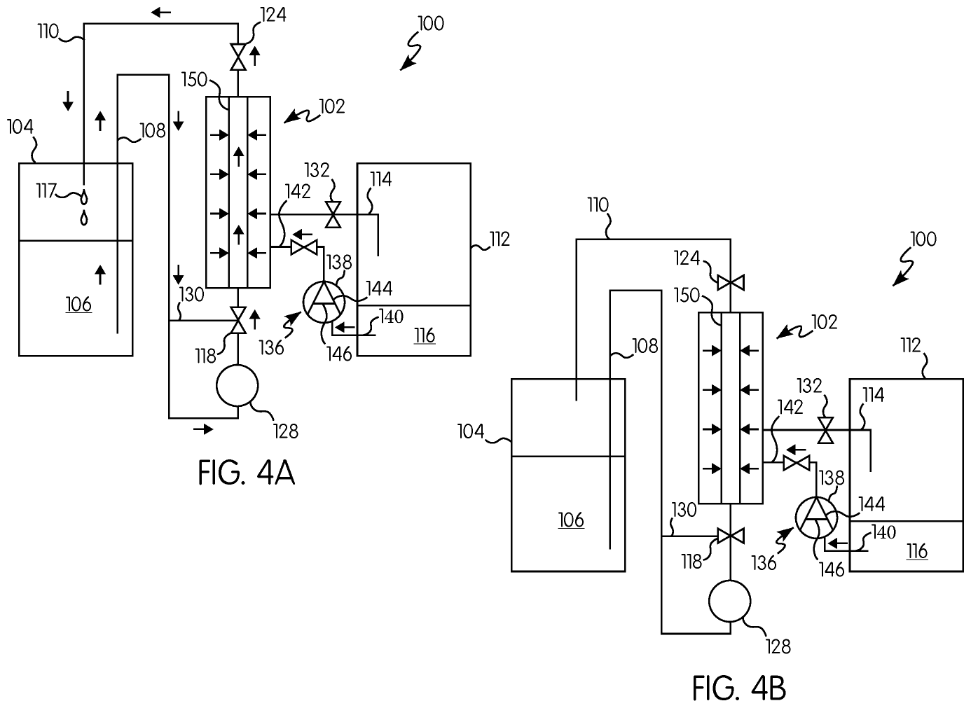

With reference to FIG. 2, the at least one filter element 102 may be a crossflow filter element configured to pass the feed solution 106 tangentially across a filtration membrane 150. The at least one filter element 102 has a housing 152 that encloses the filtration membrane 150. The housing 152 has a feed inlet 154 configured for receiving a feed flow, such as the feed solution 106 by way of the feed line 108. The housing 152 further has a concentrate outlet 156 for delivering the concentrate flow, such as the concentrate product 117, by way of the concentrate return line 110. A permeate outlet 158 is configured for delivering the permeate flow, such as the permeate product 116, through the permeate outlet line 114. As shown in FIG. 3, the feed inlet 154 and the concentrate outlet 156 may be provided on a first side 150a of the filtration membrane 150 and the permeate outlet 158 may be provided on the second side 150b of the filtration membrane 150 positioned opposite the first side 150a. During a filtration operation, the feed flow, such as the feed solution 106, may be flowed into the feed inlet 154 and may exit the housing 152 of the at least one filter element 102 out of the concentrate outlet 156 as the concentrate product 117 and out of the permeate outlet 158 as the permeate product 116.

With reference to FIG. 3, the filtration membrane 150 may be a porous material configured to allow a portion of the feed solution 106 to pass therethrough. The filtration membrane 150 may be designed to include pores 162 of any size appropriate for a specific filtering application. The size of the pores of the filtration membrane 150 may range from less than 10 nm to 10 μm or larger. The filtration membrane 150 may be a microfiltration membrane or an ultrafiltration membrane. The filtration membrane 150 may allow for the filtration system 100 to operate at a high flux rate.

With reference to FIGS. 2-3, the filtration membrane 150 may be a spiral wound filtration membrane. In some embodiments or aspects, the filtration membrane 150 may be made from a single sheet or layer of membrane material that is spirally wound about a central axis. In other embodiments or aspects, the filtration membrane 150 may be made from a plurality of sheets or layers of membrane material that are stacked on top of each other and spirally wound about a central axis. As shown in FIG. 3, the feed solution 106 flows through a feed channel 160 tangentially across the surface of the filtration membrane 150 in a direction of arrow A that is substantially parallel to a longitudinal direction of the filtration membrane 150 indicated by arrow B. As the feed solution 106 flows across the surface of the filtration membrane 150, a portion of the feed solution 106 flows through the pores 162 in a direction of arrow C and into a spiral permeate passage 164. The direction of arrow C is substantially perpendicular to the longitudinal direction of the filtration membrane 150 indicated by arrow B. The portion of the feed solution 106 that flows through the pores 162 of the filtration membrane 150 is the permeate product 116, while the portion of the feed solution 106 having a particle size larger than the size of the pores 162 flows out of the at least one filter element 102 as the concentrate product 117 in a direction of arrow D. The permeate product 116 flows through the spiral permeate passage 164 toward a permeate channel 166 having a plurality of openings 168 for receiving the permeate product 116 from the spiral permeate passage 164 into to the permeate channel 166. The permeate channel 166 is in fluid communication with the permeate outlet 158 (shown in FIG. 2) for delivering the permeate product 116 out of the at least one filter element 102.

In embodiments or aspects where a plurality of filter elements 102 are used in a series or a parallel arrangement, the filtration membrane 150 may be the same or different in each of the plurality of filter elements 102. For example, the filtration membrane 150 in one filter element 102 may be made from the same material or a different material as the filtration membrane 150 in another filter element 102. Additionally, the average pore size of the filtration membrane 150 in one filter element 102 may be the same or different than the average pore size of the filtration membrane 150 in another filter element 102.

The filtration membrane 150 may be made of polymeric material. Polymeric material that may be used for the filtration membrane 150 may include cellulose acetate, nitrocellulose, and cellulose esters (CA, CN, and CE), polysulfone (PS), polyether sulfone (PES), polyacrylonitrile (PAN), polyamide, polyimide, polyethylene and polypropylene (PE and PP), polytetrafluoroethylene (PTFE), polyvinylidene fluoride (PVDF), polyvinylchloride (PVC), or a combination thereof. The filtration membrane 150 may be a composite membrane, such as a polymer membrane with inorganic filler therein. Such fillers may include particles of silica, titanium oxide, iron oxide, calcium oxide, copper oxide, zinc oxide, antimony oxide, zirconium oxide, magnesium oxide, alumina, molybdenum disulfide, zinc sulfide, barium sulfate, strontium sulfate, calcium carbonate, magnesium carbonate, magnesium hydroxide, and mixtures thereof. In one example, the finely divided, particulate filler includes an inorganic filler material from the group of silica, alumina, calcium oxide, zinc oxide, magnesium oxide, titanium oxide, zirconium oxide, and mixtures thereof. The composite membrane may be a multi-layer membrane having the composite layer overlay any woven (e.g., PP, PE, polyester, or any blend) materials.

The feed solution 106 may be separated into permeate product 116 and concentrate product 117 using an ultrafiltration process. The filtration membrane 150, to effect this separation, may be made from any of the membrane materials listed herein. This separation can also be accomplished by use of a hydrophilic or hydrophobic membrane, or an ionic separation using a charged membrane. In the case of oil-water separation, the oil may not be a particulate, but it may instead be in the form of an emulsion or a phase-separated system. In this case, the use of a hydrophilic and/or an oleophobic membrane may be used.

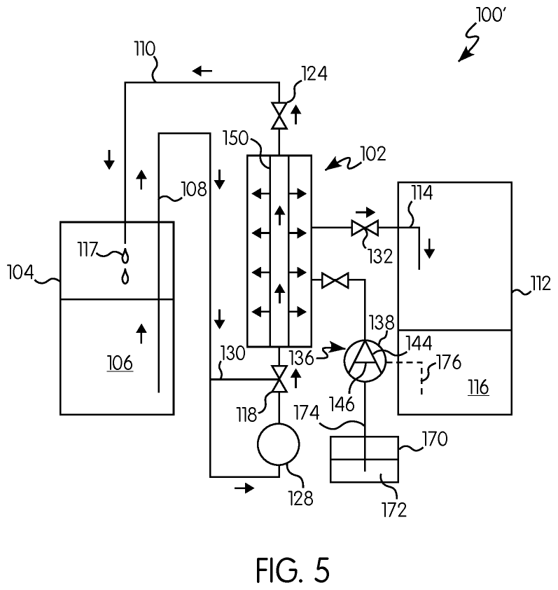

With reference to FIG. 5, a filtration system 100′ is shown in accordance with another embodiment or aspect of the present disclosure. The components of the filtration system 100′ shown in FIG. 5 are substantially similar or identical to the components of the filtration system 100 described herein with reference to FIG. 1. Accordingly, reference numerals in FIG. 5 are used to illustrate identical components of the corresponding reference numerals in FIG. 1. As the previous discussion regarding the filtration system 100 shown in FIG. 1 is applicable to the filtration system 100′ shown in FIG. 5, only the relative differences between the two filtration systems are discussed hereinafter.

With reference to FIG. 5, the filtration system 100′ has a backwash tank 170 having a backwash fluid 172 therein. The backwash fluid 172 may be the same as the permeate product 116 or different from the permeate product 116. In some examples, the backwash fluid 172 is a cleaning solution configured to facilitate cleaning of the filtration membrane 150. The backwash pump 138 is in fluid communication with the backwash fluid 172 in the backwash tank 170 by way of a backwash supply line 174. In some examples, the backwash pump 138 may have a separate permeate supply line 176 such that the backwash pump 138 is in fluid communication with the backwash fluid 172 in the backwash tank 170 by way of the backwash supply line 174 and with the permeate product 116 in the permeate tank 112 by way of the backwash supply line 174.

Having described the structure of the filtration system 100, a method of operating the filtration system 100 between a filtration mode and a backwashing mode will now be described with reference to FIGS. 1 and 4A-4D. FIG. 1 shows the filtration system 100 in the filtration mode, while FIGS. 4A-4D illustrate various phases of the backwashing mode. In FIGS. 4A-4C, the feed shutoff valve control device 120, the concentrate shutoff valve control device 126, the permeate shutoff valve control device 134, and the controller 122 have been omitted for clarity. In FIGS. 1 and 4A-4D arrows are used to indicate a direction of fluid flow through the filtration system 100.

With reference to FIG. 1, during the filtration mode, the feed solution 106 is delivered to the at least one filter element 102 through the feed line 108 using the feed pump 128. The feed solution 106 is delivered to the feed inlet 154 (shown in FIG. 2) of the at least one filter element 102. The feed shutoff valve 118 is in the open position to allow flow of the feed solution 106 from the feed tank 104 to the at least one filter element 102 by way of the feed line 108 and the pump 128. As the feed solution 106 enters the at least one filter element 102, a portion of the feed solution 106 passes through the filtration membrane 150 as the permeate product 116. The filtered permeate product 116 is delivered from the at least one filter element 102 through the permeate outlet 158 (shown in FIG. 2) to the permeate tank 112 by way of the permeate outlet line 114 under a positive fluid pressure due to operation of the feed pump 128. The permeate shutoff valve 132 is in the open position to allow the permeate product 116 to flow to the permeate tank 112 through the permeate outlet line 114.

With continued reference to FIG. 1, a portion of the feed solution 106 that does not pass through the filtration membrane 150 flows out of the at least one filter element 102 through the concentrate outlet 156 (shown in FIG. 2) as the concentrate product 117. The concentrate product 117 is delivered from the at least one filter element 102 to the feed tank 104 by way of the concentrate return line 110. The concentrate shutoff valve 124 is in the open position to allow the flow of the concentrate product 117 through the concentrate return line 110. During operation of the filtration system 100 in the filtration mode, the backwashing section 136 is turned off.

As described herein, filter cake accumulates on the surface of the filtration membrane 150 during the filtration operation, which reduces flux and permeate flow. In order to remove the filter cake from the surface of the filtration membrane 150, the filtration system 100 is configured to operate a backwashing operation, wherein a direction of flow across the filtration membrane 150 is inverted by flowing the permeate product 116 into the feed to lift the fouling layer from the surface of the filter membrane 150. The backwashing operation may be implemented in a plurality of phases, which can be performed in a sequential order, or a non-sequential order.

With reference to FIG. 4A, a crossflow flush phase of the backwashing operation is shown. In the crossflow flush phase, the backwash pump 138 is activated and set to operate at a first pressure or flow rate. The first pressure or flow rate may be a function of air pressure supplied by the compressed air source 148 (shown in FIG. 1). The backwash pump 138 is operative for pumping the permeate product 116 from the permeate tank 112 (and/or pumping the backwash fluid 172 from the backwash tank 170 shown in FIG. 5) to the at least one filter element 102 in a flow direction that is opposite to a normal flow direction during the filtration operation. The backwash pump 138 takes in the permeate product 116 from the permeate tank 112 through the permeate intake line 140 and delivers the permeate product 116 to the at least one filter element 102 through the permeate delivery line 142 and the permeate outlet 158 of the at least one filter element 102 (shown in FIG. 2). With activation of the backwash pump 138, the backwash shutoff valve 145 is opened to allow flow of the permeate product 116 to the at least one filter element 102 and the permeate shutoff valve 132 is closed to prevent flow of the permeate product 116 from the at least one filter element 102 to the permeate tank 112.

During the crossflow flush phase of backwashing, the output of the feed pump 128 is reduced from a first feed rate (i.e., pressure or flow) to a second feed rate lower than the first feed rate. The second feed rate may be 25-100% of the first feed rate. In some embodiments or aspects, the second feed rate may be a function of the first pressure or flow rate of the backwash pump 138 and a maximum desired backwashing pressure or flow rate. For example, the second feed rate of the feed pump 128 may be such that, when combined with the first pressure or flow rate of the backwash pump 138, the maximum desired backwashing pressure or flow rate is equal to or higher than a transmembrane pressure across the filtration membrane 150 during the filtration operation.

The second feed rate of the feed pump 128 is lower than the first pressure or flow rate of the backwash pump 138. In this manner, the backwash pump 138 generates a net positive pressure across the filtration membrane 150 in a direction from the second side 150b to the first side 150a. This pressure difference forces the permeate product 116 to flow through the filtration membrane 150, thereby removing the filter cake from the surface of the filtration membrane 150. The pulsatile operation of the backwash pump 138 may create pressure pulses which further help dislodge the filter cake and remove it from the surface of the filtration membrane 150. The removed filter cake and the permeate product 116 are combined with the feed solution 106 pumped by the feed pump 128 and washed away through the at least one filter 102 and into the feed tank 104 by way of the concentrate outlet 156 (shown in FIG. 2) and the concentrate return line 110. During operation of the filtration system 100 in the crossflow flush phase of the backwashing operation, the feed shutoff valve 118 and the concentrate shutoff valve 124 are open to allow fluid flow through the feed line 108 and the concentrate return line 110, respectively. The filtration system 100 may be operated in the crossflow flush phase of the backwashing process for a first predetermined period of time, such as 5-120 seconds. In some embodiments or aspects, the controller 122 may have a timer for controlling the activation and deactivation of the crossflow flush phase of the backwashing process.

With reference to FIG. 4B, a priming phase of the backwashing operation is shown. In the priming phase, the feed pump 128 is stopped and the feed shutoff valve 118 and the concentrate shutoff valve 124 are closed to block fluid flow through the feed line 108 and the concentrate return line 110, respectively. The backwash pump 138 is operated to take in the permeate product 116 from the permeate tank 112 through the permeate intake line 140 and flow the permeate product 116 to the at least one filter element 102 through the permeate delivery line 142. The priming phase may be operated before or after the crossflow flush phase.

During the priming phase of the backwashing operation, the backwash pump 138 may be operated at a same pressure as during the crossflow flush phase, or at a different pressure (i.e., higher or lower) than during the crossflow flush phase. In some examples, the backwash pump 138 is operated at a higher pressure in the priming phase than the crossflow flush phase of the backwashing operation. The permeate product 116 fills the at least one filter element 102 such that the pressure across the filtration membrane 150 is equalized. The backwash pump 138 may be operated at a pressure that is equal to or higher than an average transmembrane pressure during the filtration operation. The transmembrane pressure may be defined as an average of feed and concentrate pressures minus the permeate pressure. In some examples, the backwash pump 138 may be operated to create a transmembrane pressure of around 5 psi to 35 psi, with an average transmembrane pressure during filtration operation being around 5 psi to 15 psi. The backwash pump 138 may be configured to automatically stop when the target transmembrane pressure is reached. The filtration system 100 may be operated in the priming phase of the backwashing process for a second predetermined period of time, such as 5-120 seconds. In some embodiments or aspects, the controller 122 may have a timer for controlling the activation and deactivation of the priming phase of the backwashing process.

With reference to FIG. 4C, a concentrate flush phase of the backwashing operation is shown. The concentrate flush phase follows the priming phase shown in FIG. 4B. The backwash pump 138 is operated to take in the permeate product 116 from the permeate tank 112 through the permeate intake line 140 and flow the permeate product 116 to the at least one filter element 102 through the permeate delivery line 142 and the permeate outlet 158 of the at least one filter element 102 (shown in FIG. 2). The concentrate shutoff valve 124 is opened from its closed position, thereby allowing fluid from the at least one filter element 102 to flow through the concentrate return line 110 and the concentrate outlet 156. The backwash pump 138 generates a net positive pressure across the filtration membrane 150 in a direction from the second side 150b to the first side 150a (shown in FIG. 3). This pressure difference forces the permeate product 116 to flow through the filtration membrane 150, thereby removing the filter cake from the surface of the filtration membrane 150. The pulsatile operation of the backwash pump 138 may create pressure pulses which further help dislodge the filter cake and remove it from the surface of the filtration membrane 150. The removed filter cake and the permeate product 116 are washed away through the at least one filter 102 and into the feed tank 104 by way of the concentrate outlet 156 (shown in FIG. 2) and the concentrate return line 110.

During operation of the filtration system 100 in the concentrate flush phase of the backwashing operation, the feed shutoff valve 118 is closed to block fluid flow through the feed line 108 and the feed outlet 154 of the at least one filter element (shown in FIG. 2). The filtration system 100 may be operated in the concentrate flush phase of the backwashing process for a third predetermined period of time, such as 5-120 seconds. In some embodiments or aspects, the controller 122 may have a timer for controlling the activation and deactivation of the concentrate flush phase of the backwashing process.

With reference to FIG. 4D, a feed flush phase of the backwashing operation is shown. The feed flush phase follows the priming phase shown in FIG. 4B. The backwash pump 138 is operated to take in the permeate product 116 from the permeate tank 112 through the permeate intake line 140 and flow the permeate product 116 to the at least one filter element 102 through the permeate delivery line 142 and the permeate outlet 158 of the at least one filter element 102 (shown in FIG. 2). The concentrate shutoff valve 124 is closed from its open position, thereby blocking fluid from the at least one filter element 102 to flow through the concentrate return line 110 and the concentrate outlet 156. The feed shutoff valve 118 is maintained in the closed position to block fluid flow through the feed line 108 and the feed outlet 154 of the at least one filter element (shown in FIG. 2). The permeate product 116 pumped by the backwash pump 138 fills the at least one filter element 102 such that the pressure across the filtration membrane 150 is equalized. The feed shutoff valve 118 is then opened to allow fluid flow through the feed line 108 and the feed inlet 154 of the at least one filter element 102 (shown in FIG. 2). The backwash pump 138 generates a net positive pressure across the filtration membrane 150 in a direction from the second side 150b to the first side 150a (shown in FIG. 3). This pressure difference forces the permeate product 116 to flow through the filtration membrane 150, thereby removing the filter cake from the surface of the filtration membrane 150. The pulsatile operation of the backwash pump 138 may create pressure pulses which further help dislodge the filter cake and remove it from the surface of the filtration membrane 150. The removed filter cake and the permeate product 116 are washed away through the at least one filter 102 and into the feed tank 104 by way of the feed inlet 152 (shown in FIG. 2) and the feed line 108. In some examples, the feed shutoff valve 118 can be opened when the concentrate shutoff valve 124 is closed and without equalizing the pressure across the filtration membrane 150.

During operation of the filtration system 100 in the feed flush phase of the backwashing operation, the concentrate shutoff valve 124 is closed to block fluid flow through the concentrate return line 110. The filtration system 100 may be operated in the feed flush phase of the backwashing process for a second predetermined period of time, such as 5-120 seconds. In some embodiments or aspects, the controller 122 may have a timer for controlling the activation and deactivation of the priming phase of the backwashing process. In some examples, the third and feed flush phases may be reversed, such that the feed flush phase is operated prior to the concentrate flush phase, and after the completion of the first and priming phases.

In some embodiments or aspects, the filtration system 100 may be continuously operated between filtration and backwashing modes. For example, the filtration system 100 may be operated in the filtration mode for a first period of time, followed by operation in the backwashing mode for a second period of time. The backwashing mode may contain a plurality of phases selected from the crossflow flush phase, the priming phase, the concentrate flush phase, and the feed flush phase. The controller 122 may be programmed to automatically switch operation of the filtration system 100 between the filtration mode and the backwashing mode by controlling the state of the appropriate valves and pumps.

Although the disclosure has been described in detail for the purpose of illustration based on what are currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more feature of any other embodiment.

What is claimed is:

1. A filtration system comprising:
at least one filter element having a filtration membrane, a feed inlet and a concentrate outlet on a first side of the filtration membrane and a permeate outlet on a second side of the filtration membrane;
a feed line in fluid communication with the feed inlet, the feed line having a feed shutoff valve;
a concentrate return line in fluid communication with the concentrate outlet, the concentrate return line having a concentrate shutoff valve;
a feed pump in fluid communication with the feed inlet via the feed line and the feed shutoff valve; and
a backwash supply in fluid communication with the permeate outlet,
wherein, in a priming phase of a backwash operation, the feed shutoff valve and the concentrate shutoff valve are closed and the backwash supply is operable to deliver fluid to the at least one filtration element via the permeate outlet and equalize pressure between the first side and the second side of the filtration membrane.

2. The filtration system of claim 1, wherein, in a crossflow flush phase of the backwash operation, the feed shutoff valve and the concentrate shutoff valve are open, and the feed pump and the backwash supply are operable to deliver the fluid across the filtration membrane in a direction from the permeate outlet through the concentrate outlet.

3. The filtration system of claim 1, wherein, in a concentrate flush phase of the backwash operation, the feed shutoff valve is closed and the concentrate shutoff valve is open while the backwash supply is operable to deliver the fluid across the filtration membrane from the permeate outlet through the concentrate outlet.

4. The filtration system of claim 1, wherein, in a feed flush phase of the backwash operation, the concentrate shutoff valve is closed and the feed shutoff valve is open while the backwash supply is operable to deliver the fluid across the filtration membrane from the permeate outlet through the feed inlet.

5. The filtration system of claim 1, wherein an operating pressure of the backwash supply is higher than an operating pressure of the feed pump.

6. The filtration system of claim 1, further comprising a permeate tank in fluid communication with the permeate outlet.

7. The filtration system of claim 1, wherein the backwash supply is in fluid communication with the permeate tank.

8. The filtration system of claim 1, wherein the backwash supply is an air-operated diaphragm pump.

9. The filtration system of claim 1, wherein the at least one filtration element is a crossflow filtration element.

10. The filtration system of claim 1, wherein the filtration membrane is a spirally-wound filtration membrane.

11. A method of operating a filtration system, the method comprising:
backwashing at least one filtration element having a filtration membrane, a feed inlet and a concentrate outlet on a first side of the filtration membrane and a permeate outlet on a second side of the filtration membrane, wherein the backwashing comprises a priming phase comprising:
(a) blocking the feed inlet and the concentrate outlet; and
(b) pressurizing the filtration element with a permeate flow through the permeate outlet until a pressure within the at least one filtration element is equalized between the first side and the second side of the filtration membrane.

12. The method of claim 11, wherein the backwashing comprises a crossflow flush phase, the crossflow flush phase comprising:
(c) unblocking the feed inlet and the concentrate outlet;
(d) delivering a feed flow to the at least one filtration element through the feed inlet at a first pressure;
(e) delivering the permeate flow to the at least one filtration element through the permeate outlet at a second pressure higher than the first pressure;
(f) passing the permeate flow through the filtration membrane to combine the permeate flow with the feed flow; and
(g) delivering a combination of the permeate flow and the feed flow out of the at least one filtration element through the concentrate outlet.

13. The method of claim 11, wherein the backwashing comprises a concentrate flush phase following the priming phase, the concentrate flush phase comprising:
(h) unblocking the concentrate outlet;
(i) delivering the permeate flow to the at least one filtration element through the permeate outlet to pass the permeate flow through the filtration membrane; and
(j) delivering the permeate flow out of the at least one filtration element through the concentrate outlet.

14. The method of claim 11, wherein the backwashing comprises a feed flush phase following the priming phase, the feed flush phase comprising:
(k) unblocking the feed inlet;
(l) delivering the permeate flow to the at least one filtration element through the permeate outlet to pass the permeate flow through the filtration membrane; and
(m) delivering the permeate flow out of the at least one filtration element through the feed inlet.

15. The method of claim 11, wherein blocking the feed inlet and the concentrate outlet comprises operating a feed shutoff valve to block flow through the feed inlet and operating a concentrate shutoff valve to block flow through the concentrate outlet.

16. The method of claim 12, wherein the second pressure is equal to or higher than a transmembrane pressure during a filtration operation.

17. The method of claim 11, wherein delivering the permeate flow comprises delivering a permeate fluid through the permeate outlet via a backwash supply.

18. The method of claim 17, wherein the backwash supply is an air-operated diaphragm pump.

19. The method of claim 11, wherein the at least one filtration element is a crossflow filtration element.

20. The method of claim 11, wherein the filtration membrane is a spirally-wound filtration membrane.
